(19) United States
(12) Patent Application Publication
(10) Pub. No.: US 2024/0392720 A1
(43) Pub. Date: Nov. 28, 2024

(54) ENGINE COOLANT MANAGEMENT

(71) Applicants: Ralf Centmayer, Markdorf (DE); Dirk Winkler, Stetten (DE)

(72) Inventors: Ralf Centmayer, Markdorf (DE); Dirk Winkler, Stetten (DE)

(21) Appl. No.: 18/651,652

(22) Filed: Apr. 30, 2024

Related U.S. Application Data
(60) Provisional application No. 63/545,106, filed on Oct. 20, 2023.
(60) Provisional application No. 63/544,072, filed on Oct. 13, 2023.
(60) Provisional application No. 63/542,865, filed on Oct. 6, 2023.
(60) Provisional application No. 63/468,357, filed on May 23, 2023.

(51) Int. Cl. F01P 5/12; F01M 1/02; F01P 7/16; F01P 11/02; F01P 11/04; F02M 35/10; F02M 55/02; F02M 61/14; F04D 29/18; F04D 29/40

(52) U.S. Cl. CPC F01P 5/12; F01M 1/02; F01P 7/16; F01P 11/0285; F01P 11/029; F01P 11/04; F02M 35/10216; F02M 55/025; F02M 61/14; F04D 29/18; F04D 29/406; F01M 2001/0207

(57) ABSTRACT

The present disclosure relates to a coolant system to cool an engine assembly. The coolant system includes a coolant pump impeller with multiple concentric ribs extending axially on a first side of the coolant pump impeller and multiple vanes extending axially on a second side of the coolant pump impeller. The coolant system also includes a coolant rail to collect coolant from a water jacket that surrounds portions of cylinders and a cylinder head of the engine assembly. The coolant system further includes bleed fittings to remove trapped air as the coolant system circulates coolant through the engine assembly. First and second bleed fittings are provided on opposite corners of the engine assembly such that either the first or the second bleed fitting is at a highest point of the coolant system based on an engine orientation of the engine assembly.

### PRIORITY CLAIM

This application claims the benefit of priority from U.S. Provisional Patent Application Nos. 63/545,106 filed Oct. 20, 2023; 63/544,072 filed Oct. 13, 2023; 63/542,865 filed Oct. 6, 2023; and 63/468,357 filed May 23, 2023, the contents of which are incorporated herein by reference.

### FIELD OF THE DISCLOSURE

The disclosure generally relates to engines for vehicles, including an engine coolant management system for an engine assembly for off-road vehicles.

### BACKGROUND

An internal combustion engine of a vehicle converts thermal energy into mechanical energy to drive moving parts of the vehicle, thereby enabling motion of the vehicle. Depending on the type of vehicle, designs and structures of the engine may vary to suit the purposes and parameters of the intended vehicle. For instance, off-road vehicles, such as all-terrain vehicles (ATV), side-by-side utility terrain vehicles (UTV or side-by-side), and snowmobiles use internal combustion engines to propel the vehicle. Typically, a four-stroke internal combustion engine (ICE) includes a coolant system to circulate coolant throughout the engine.

In the conventional coolant system, a coolant pump circulates coolant through a water jacket surrounding cylinders and the cylinder head. The conventional coolant systems include a coolant pump impeller with complicated geometry that requires complex machining of the pump housing to achieve tight tolerances. For example, in a conventional coolant pump, a gap between the impeller and the pump housing is critical to efficiency of the pump. To achieve this gap, the impeller is formed with complex curvature. This curvature results in complicated tooling to form the impeller and complicated machining to minimize the gap between the impeller and the pump housing.

Furthermore, with conventional engines, the coolant that exits from the engine is collected and circulated to a radiator or heat exchanger using many hoses. These hoses are susceptible to damage and degradation over time, which increases the likelihood of a leak of the coolant and possible engine damage.

Additionally, conventional engines include several air bleed ports to bleed air trapped in the engine when coolant is added to the engine. These multiple air bleed ports must be opened and closed to remove air from the coolant system. If a precise bleeding procedure is not followed to remove the air, then the cooling performance will be degraded, which increases the likelihood of the engine overheating.

### BRIEF SUMMARY OF THE DISCLOSURE

The present disclosure is directed toward the coolant system of a vehicle engine assembly. The engine assembly has a crankcase that includes a crankshaft. The engine assembly also includes cylinders and a cylinder head. The coolant system is configured to cool the crankcase, cylinders, and cylinder head during operation of the engine assembly.

In some embodiments, the coolant system includes a coolant pump impeller. In some embodiments, the coolant pump impeller includes multiple concentric ribs that extend axially on a first side of the coolant pump impeller. In some embodiments, multiple vanes extend axially on a second side of the coolant pump impeller. The multiple vanes are configured to pump coolant. Multiple openings in the coolant pump impeller permit the coolant to pass from the first side to the second side.

In some embodiments, the concentric ribs strengthen the coolant pump impeller by adding cross-sectional structure to the coolant pump impeller. In some embodiments, the concentric ribs reduce backflow of the coolant pumped by the vanes by sealing the impeller and blocking the flow of coolant exiting the vanes. In some embodiments, the coolant pump impeller is made by molding the multiple concentric ribs and multiple vanes to extend axially with two-piece tooling. Because all molded surfaces extend axially, simple two-piece tooling can be used to make the impeller.

In some embodiments, the engine assembly includes a pump housing. In some embodiments, the pump housing is integrated into the crankcase of the engine assembly. The pump housing is configured to receive the coolant pump impeller. In some embodiments, the pump housing includes an internal face with a planar surface. In some embodiments, the multiple concentric ribs extend toward the internal face of the pump housing forming a gap.

In some embodiments, the coolant system further includes a coolant rail configured to be secured to a side of the engine assembly. In some embodiments, the coolant rail is configured to collect coolant from a water jacket that surrounds portions of cylinders and a cylinder head of the engine assembly. In some embodiments, the coolant rail includes multiple ports in fluid communication with the water jacket. In some embodiments, the coolant rail is coupled to the side of the cylinder head. In some embodiments, coolant collected by the coolant rail is transmitted to the coolant pump.

In some embodiments, the coolant rail is integrated with an intake system component. In some embodiments, the coolant rail and the intake system component are cast integrally together to form a single monolithic unit. In some embodiments, the intake system component provides air and fuel to the cylinder head. In some embodiments, the intake system component defines multiple intake channels to receive the air and fuel. In some embodiments, each intake channel defines a fuel injector port to receive fuel from a fuel injector secured to the fuel injector port. In some embodiments, multiple fuel injectors are coupled to a fuel rail that provides fuel to the fuel injectors.

In some embodiments, the coolant rail further defines a thermostat housing to house a thermostat for the coolant system. Using the coolant rail, in some embodiments, coolant that enters the coolant rail is fed through the thermostat directly without hoses. In some embodiments, one side of the thermostat housing is removable to allow insertion of the thermostat into the thermostat housing.

In some embodiments, the coolant system further includes bleed fittings to remove trapped air as the coolant system circulates coolant through the engine assembly. In some embodiments, the engine assembly includes a first and second bleed fitting in fluid communication with the coolant system. In some embodiments, the first and second bleed fittings are provided on opposite corners of the engine assembly such that either the first or the second bleed fitting is at a highest point of the coolant system based on an engine orientation of the engine assembly. In some embodiments, the engine orientation includes the tilt of the engine assembly in relation to the vehicle. In some embodiments, the first bleed fitting is provided at the top of the water jacket of the cylinder head. In some embodiments, the second bleed fitting is provided at an end of the coolant rail. The first and second bleed fittings minimize trapped air introduced into the coolant system from filling the coolant system with the coolant.

In some embodiments, the first and second bleed fittings accommodate more than one engine orientation. In some embodiments, either the first or the second bleed fitting is at the highest point of the coolant system for any of the engine orientations. In some embodiments, for a given engine orientation, either the first or the second bleed fitting provides a single bleeding point for the entire coolant system.

In some embodiments, the engine assembly is installed in the vehicle with a given engine orientation. In some embodiments, either the first or the second bleed fitting is selected to provide the coolant to an expansion tank based on which of the first or second bleed fitting is positioned at the highest point of the coolant system. In some embodiments, a fluid line is connected from the selected bleed fitting to the expansion tank. By accommodating multiple engine orientations, the bleed fittings facilitate modularity of the engine assembly.

### BRIEF DESCRIPTION OF THE DRAWINGS

Preferred embodiments of the present disclosure are described in detail below with reference to the following drawings.

FIGS. 1 and 2 are perspective views of off-road vehicles.

FIGS. 3A-3C are isometric views of the engine assembly with coolant system.

FIG. 4 is an isometric view of portions of the engine assembly with the coolant system.

FIG. 5 is an isometric view of a first side of a coolant pump impeller.

FIG. 6 is an isometric view of a second side of the coolant pump impeller.

FIG. 7 is a cross-sectional view of the coolant pump impeller.

FIGS. 8A and 8B are cross-sectional isometric views of a coolant pump with the coolant pump impeller.

FIGS. 8C and 8D are isometric views of the engine crankcase with the integrated coolant pump housing.

FIGS. 9A and 9B are cross-sectional elevation views of a coolant pump with the coolant pump impeller.

FIG. 10 is an isometric view of portions of the engine assembly with a coolant rail.

FIG. 11 is an elevation view of portions of the engine assembly with a coolant rail.

FIG. 12A is an isometric view of portions of the coolant rail and intake system component.

FIG. 12B is an isometric view of the cylinder head showing the attachment interface for the coolant rail and intake system component.

FIG. 13 is a cross-sectional elevation view of the engine assembly with the coolant rail and intake system component.

FIG. 14 is an isometric view of the engine assembly in a first configuration.

FIG. 15 is an isometric view of the engine assembly in a second configuration.

FIG. 16 is an isometric view of portions of the engine assembly with bleed fittings.

FIGS. 17A and 17B are isometric views of portions of the engine assembly with bleed fittings and coolant flow.

FIG. 18 is an isometric view of portions of a vehicle with a coolant system for an engine assembly.

FIG. 19 is an isometric view of portions of the vehicle with the coolant system for the engine assembly.

FIG. 20 is an isometric view of portions of the vehicle with the fluid lines for the coolant system.

FIG. 21 is an isometric view of portions of the vehicle with the fluid lines for the coolant system.

FIG. 22 is an isometric view of the bottom of the vehicle with a heat exchanger.

FIG. 23 is an isometric view of the coolant system including a radiator and a heat exchanger.

FIG. 24 is a side-elevational view of the tunnel, heat exchanger, and track drive wheel.

### DETAILED DESCRIPTION OF THE PREFERRED EMBODIMENTS

An engine assembly in accordance with the principles of the disclosure is generally indicated at reference number 102 in the Figures of the attached drawings, wherein numbered elements in the Figures correspond to like numbered elements herein.

The disclosures of the following applications are hereby incorporated by reference: application Ser. No. 18/650,021, filed Apr. 29, 2024; Application Ser. No. 18/649,993, filed Apr. 29, 2024; Application Ser. No. 63/537,179, filed Sep. 7, 2023; Application Ser. No. 63/543,461, filed Oct. 10, 2023; and Application Ser. No. 63/528,411, filed Jul. 23, 2023.

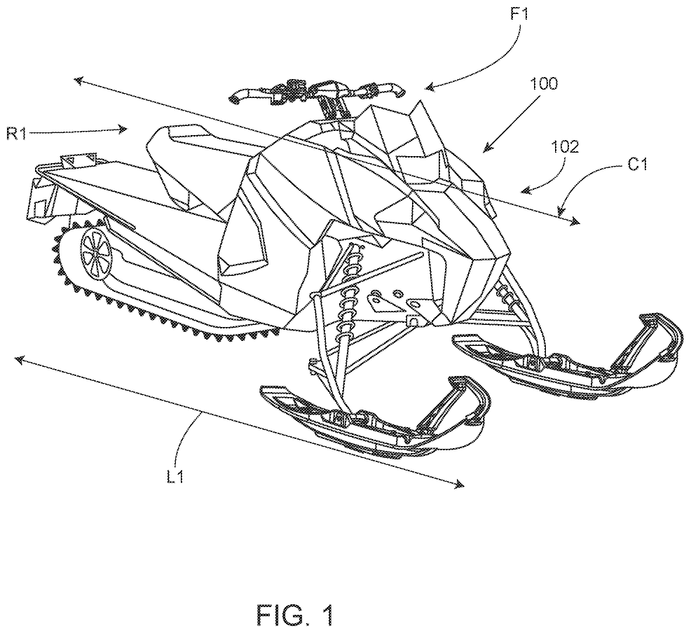

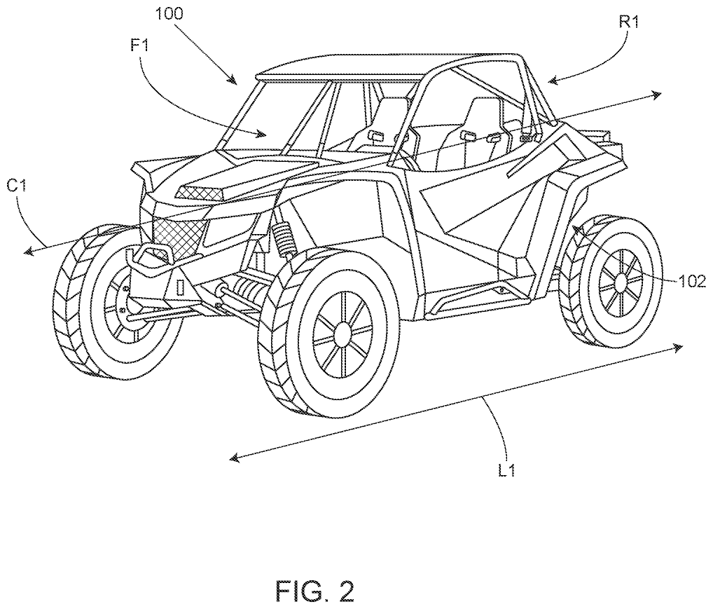

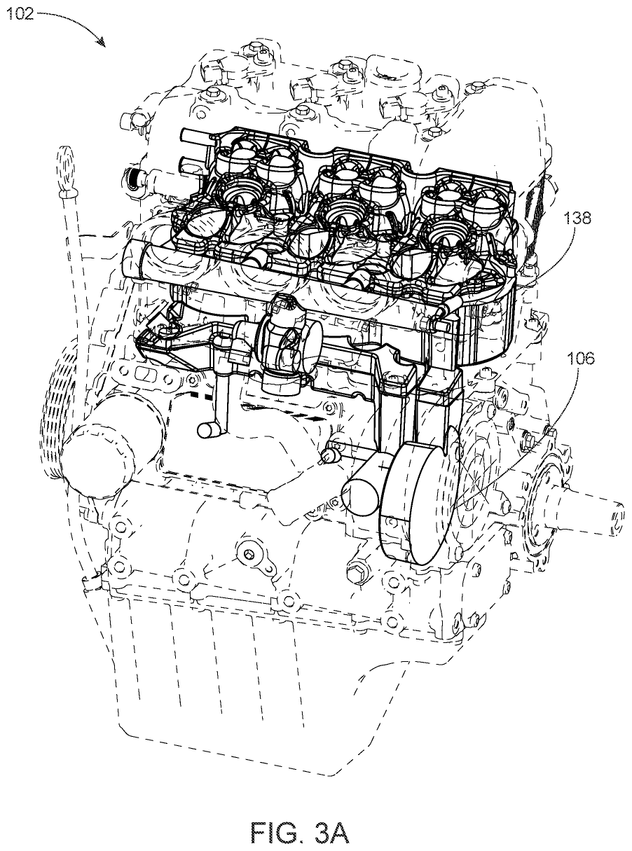

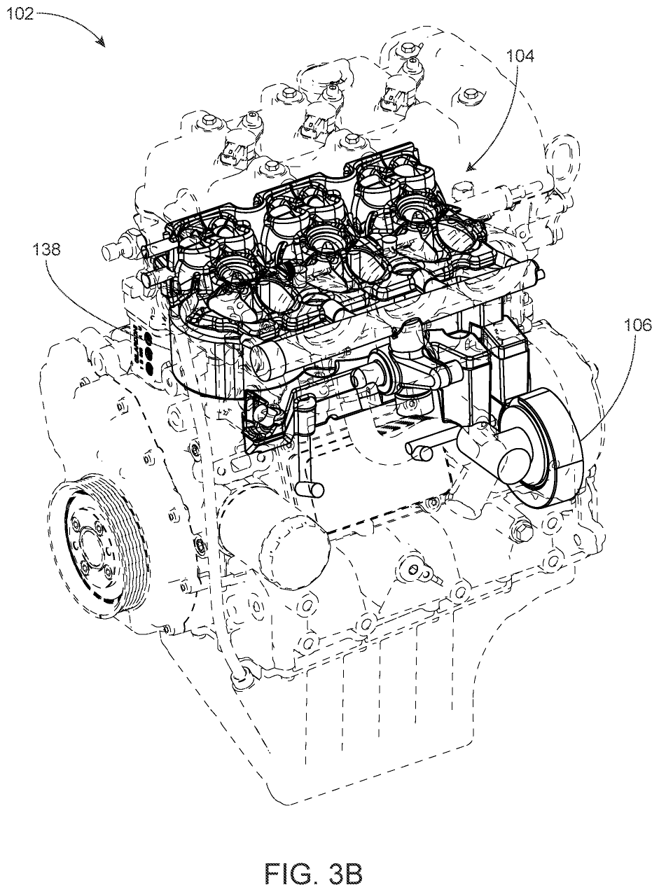

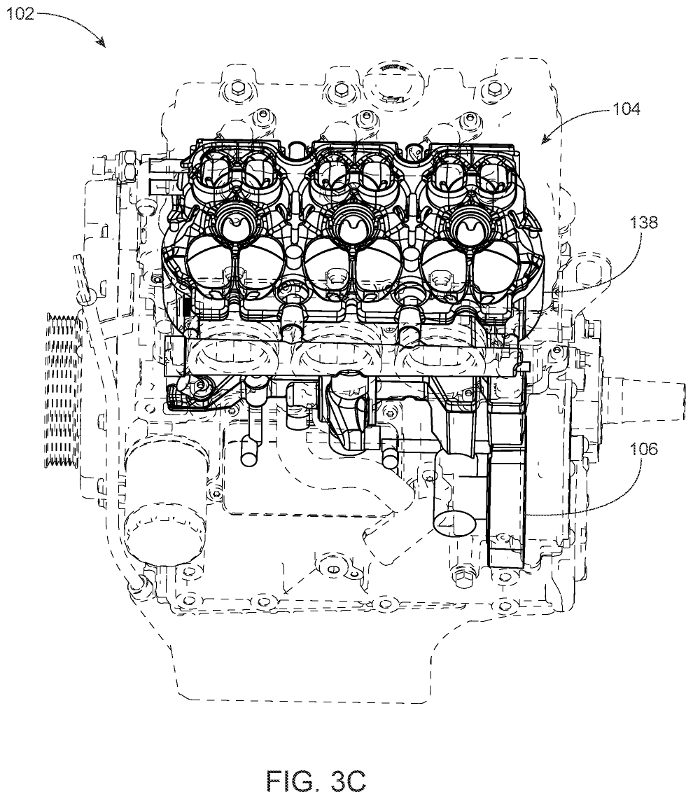

The present disclosure relates to engine assemblies of an off-road vehicle, represented as 100. FIGS. 1 and 2 illustrate off-road vehicles, such as a snowmobile and a side-by-side vehicle. Accordingly, the reference numeral 100 generally represents an off-road vehicle. The vehicle 100 extends from a front side (F1) to a rear side (R1) in a longitudinal direction that extends along a longitudinal axis (L1) of the vehicle 100 and a central axis (C1) of the vehicle 100 extending in the longitudinal direction and passing through a center of the vehicle 100. As shown in FIG. 3, the vehicle 100 has an engine assembly 102 (behind body panels not shown in FIG. 3) and other components that facilitate translation of combustion energy or thermal energy to rotational energy for enabling movement of the vehicle 100.

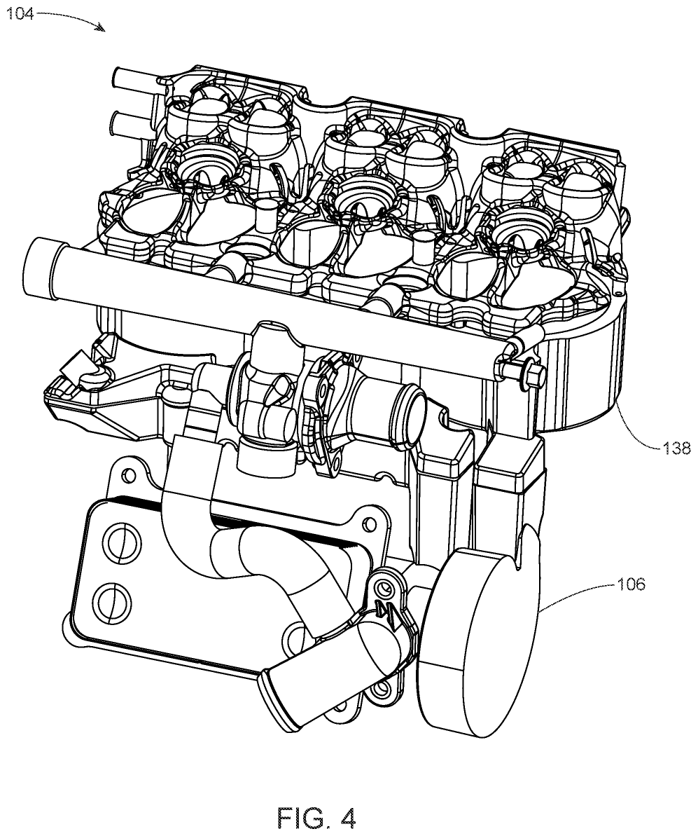

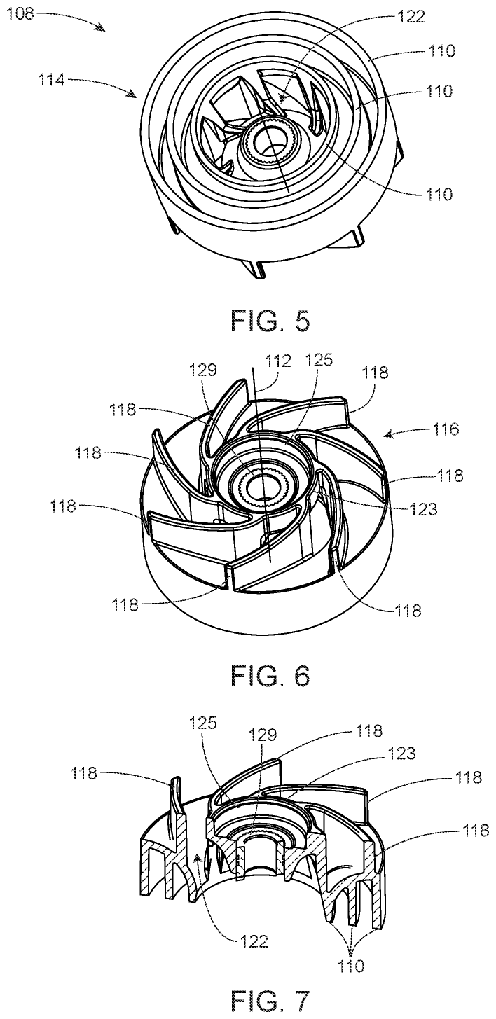

FIGS. 3A-3C and 4 illustrate an engine assembly 102 that includes a coolant system 104 to circulate coolant through channels within the engine. The coolant channels are referred to as a water jacket 138 that surrounds the cylinders and cylinder head of the engine assembly 102. The coolant system 104 includes a coolant pump 106 that generates pressure to circulate the coolant. The coolant pump 106 includes a coolant pump impeller 108 (see, e.g., FIGS. 5-7) that rotates to move the coolant through the coolant system 104.

In some embodiments, the coolant pump impeller 108 includes multiple concentric ribs 110 extending axially on a first side 114 of the coolant pump impeller 108. As used herein, the term “extending axially” refers to features that project along or substantially parallel to a central axis 112 of the coolant pump impeller 108. Thus, the concentric ribs 110 project out from the first side 114 along the central axis 112. In some embodiments, the coolant pump impeller 108 includes two or more concentric ribs 110 that extend axially on the first side 114. In the embodiment of FIG. 6, the coolant pump impeller 108 includes three concentric ribs 110.

In some embodiments, the ends of the multiple concentric ribs 110 terminate at a plane offset from the first side 114. Thus, the ends of the multiple concentric ribs 110 may be positioned to conform to a planar surface. The concentric ribs 110 strengthen the coolant pump impeller 108 by adding additional cross-sectional depth to the coolant pump impeller 108. The concentric ribs 110 also reduce or prevent backflow of coolant when positioned along a planar surface without the need to provide tight tolerances by providing multiple barriers to the flow of coolant around the concentric ribs 110.

In some embodiments, on a second side 116 opposite the first side 114, the coolant pump impeller 108 includes a plurality of vanes 118 extending axially outward therefrom. The vanes 118 are configured to pump coolant as the coolant pump impeller 108 rotates. In some embodiments, each of the multiple vanes 118 are formed with a curve along a radial direction. The vanes sweep outwardly from a central hub 123 on the second side 116 of impeller 108. The hub 123 is generally cylindrical and extends along axis 112. As the vanes extend outwardly, away from hub 123 they sweep in a clockwise direction as seen from the top of second side 116 from the cylindrical hub 123 to the outer edge of impeller 108. See FIGS. 5-7. As vanes 118 extend outwardly they cross concentric ribs 110 on the opposite side (first side 114) of impeller 108. Vanes 118 extend to the outer edge of impeller 108 for close fitment in the cavity of the coolant pump 106. As shown in FIG. 5, the inner end of the vanes 118 are positioned radially inward of the innermost concentric rib 110. In a non-limiting example, a radial line extending from the central axis 112 to the outer edge of impeller 108 may pass through an inner portion of one vane 118 and an outer portion of an adjacent vane 118. In other words, in a preferred embodiment, the sweep of the vanes 118 is such that they partially overlap along a radial direction of the impeller 108.

In some embodiments, the coolant pump impeller 108 includes multiple openings 122 to permit the coolant to pass from the first side 114 to the second side 116. Thus, the coolant may flow past the concentric ribs 110 to the vanes 118. In some embodiments, the coolant pump impeller 108 includes the central hub 123 that connects the vanes 118. The openings 122 may be defined by or at least partially by the innermost concentric circle 110 and extend outwardly around the central hub 123. Thus, the openings 122 extend from the first side 114 to the second side 116 radially inward of the innermost concentric circle 110 to the vanes 118 radially outward of the central hub 123. Thus, the flow of coolant is through the innermost concentric circle 110 then outward of the central hub 123 and propelled past the vanes 118 to circulate through the engine.

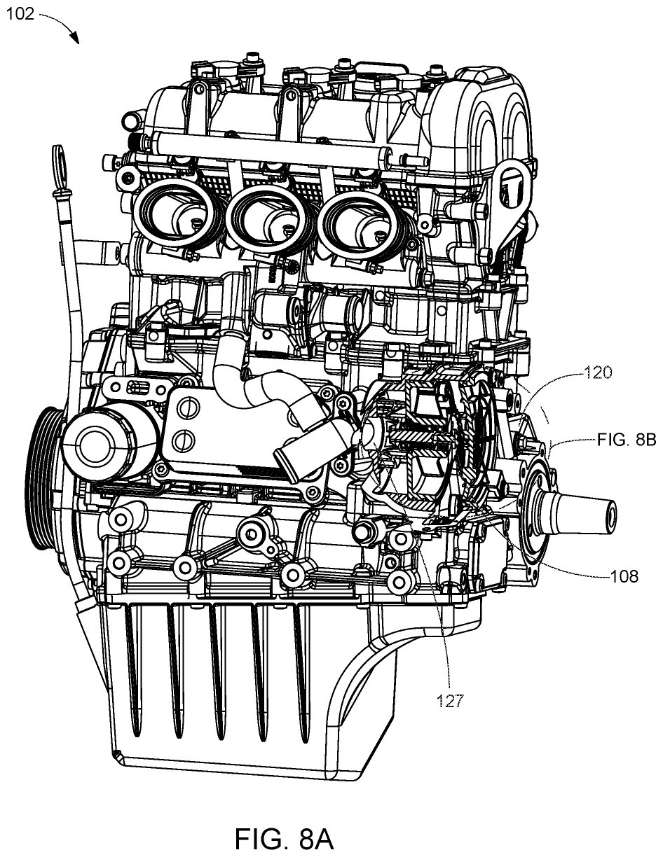

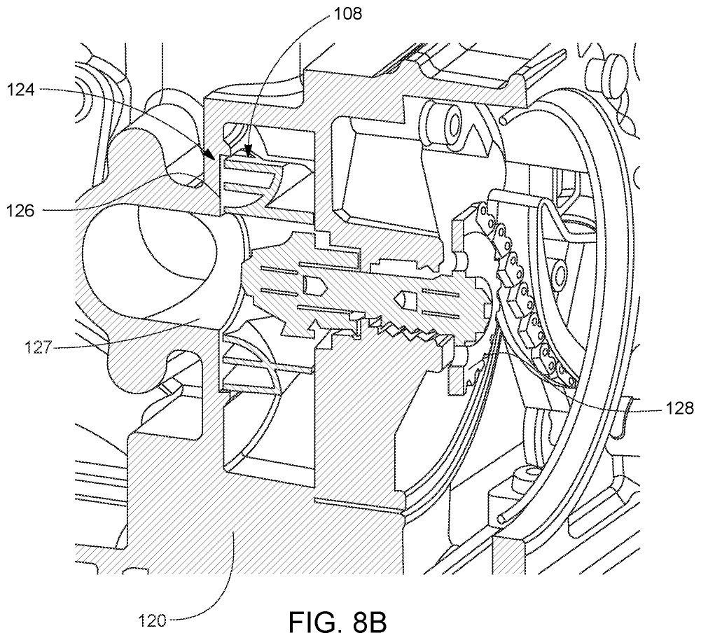

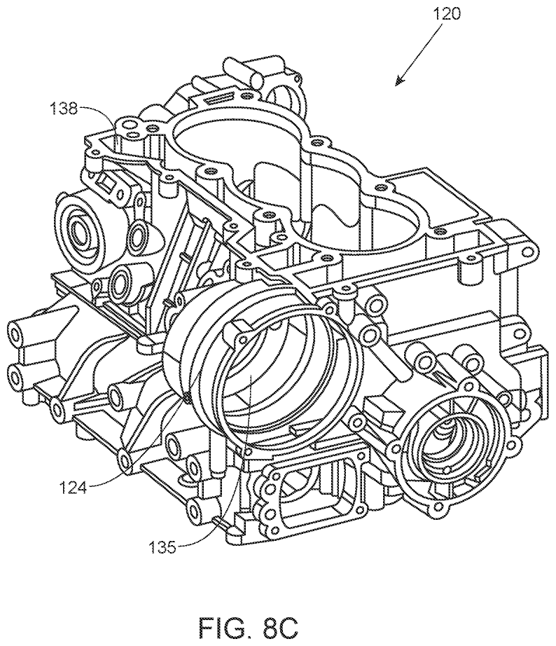

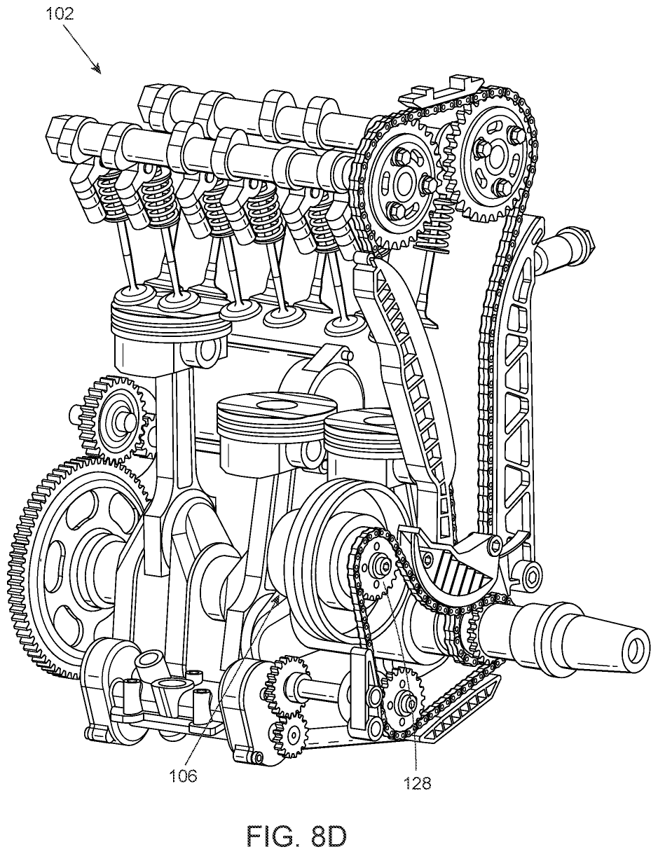

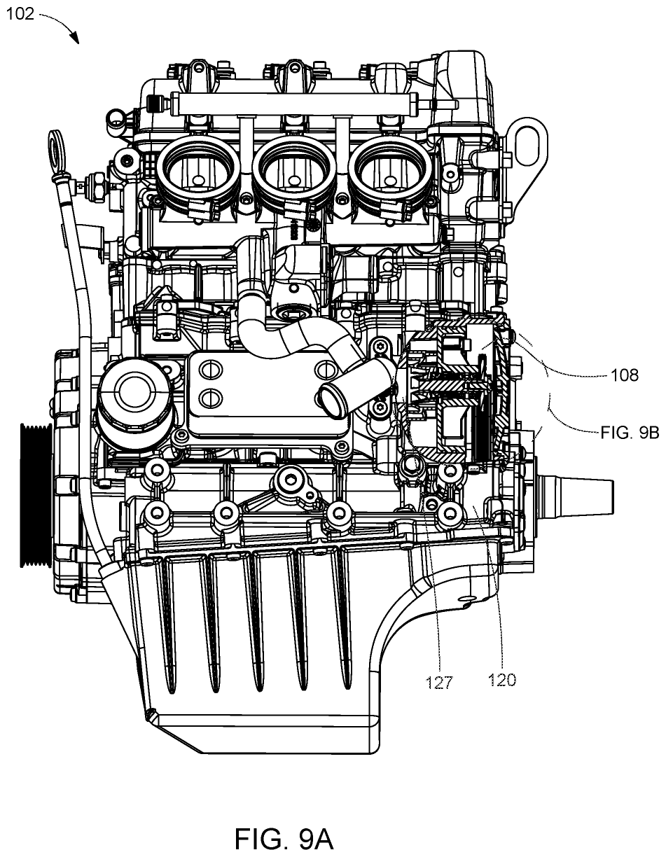

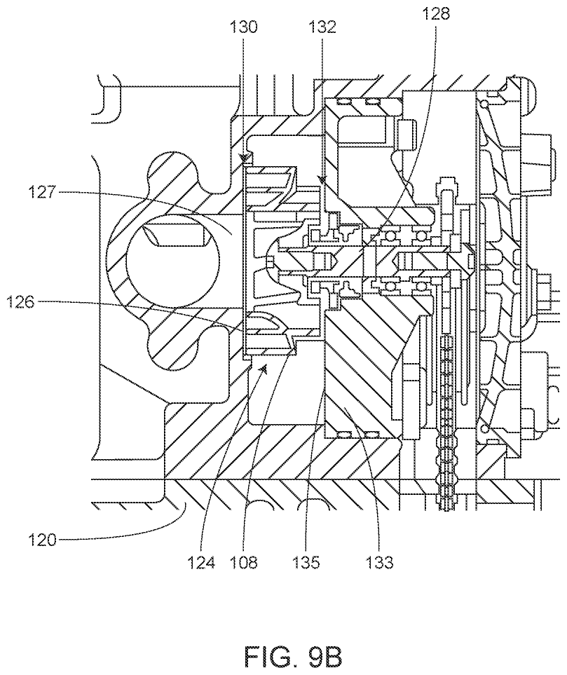

The central hub 123 is configured to attach to a drive 128 (see, e.g., FIGS. 8A and 8B) powered by the crankshaft of the engine assembly 102. FIGS. 6-7 show a circular pocket 125 in the hub 123. The center of the hub 123 may include a metallic insert 129. The hub 123 of the impeller is pressed onto the water pump drive 128 shaft via the pocket 125. This forms a dependable seal at the connection. See FIGS. 8B, 9B.

In some embodiments, the engine assembly 102 includes a pump housing 124 to house the coolant pump impeller 108. In an illustrative example, the pump housing 124 is integrally formed in the crankcase 120. The pump housing 124 defines an internal face 126 surrounding an opening 127 that is in fluid communication with the coolant channels of the water jacket 138. It should be noted that in the cross-sectional view of FIGS. 8A and 8B, the ends of the concentric ribs 110 are positioned adjacent the internal face 126 of the pump housing 124 with the end of the innermost concentric rib 110 positioned outboard of and immediately adjacent the portion of the internal face 126 defining the opening. In a non-limiting example, all of the ends of the concentric ribs 110 are positioned outboard of the opening 127 defined by the internal face 126. Thus, the ends of the multiple concentric ribs 110 are positioned along the planar internal face 126 of the pump housing 124. As the water flows through the openings 122 from the first side 114 to the second side 116, the multiple ribs 110 effectively seal the coolant pump 106 from significant upstream fluid back flow. In some embodiments, the internal face 126 is a planar surface that aligns with the ends of the concentric ribs 110 of the coolant pump impeller 108 to form a first gap 130 (see, e.g., FIGS. 9A and 9B). In some embodiments, the internal face 126 is a machined surface that is slightly recessed to receive the ends of the concentric ribs 110 within the recess as shown in FIGS. 8B and 9B. Thus, the impeller design allows the machining of the face 126 of the internal pump housing 124 to be a flat face (i.e., the face that opposes the ends of the concentric ribs 110) rather than a curved contour that would be typical of the interface between the housing and impeller in a conventional coolant pump. In some embodiments, the internal face 126 of the internal pump housing 124 is an as-cast surface without machining since this design allows for looser tolerances.

In some embodiments, a cover 133 is configured to position the coolant pump impeller 108 within the pump housing 124. The cover 133 is positioned within the pump housing 124 outboard of the pump impeller 108 with a cover face 135 that defines a planar surface that is positioned along the vanes 118 of the coolant pump impeller 108. As shown in FIG. 9B, the pump housing 124 defines a first chamber that receives the pump impeller 108, and a second chamber positioned outboard of the first chamber that receives the cover 133. The second chamber has a diameter that is greater than the diameter of the first chamber so that a portion of the inboard side of the cover 133 is positioned along the vanes 118, and a portion of the inboard side of the cover 133 is positioned to abut a planar surface of the crankcase 120 that surrounds the opening to the first chamber. One or more seals may be provided between the crankcase walls defining the second chamber and the outer perimeter of the cover as shown in FIG. 9B. In some embodiments, the vanes 118 and the planar face 135 of the cover 133 form a second gap 132 (see, e.g., FIG. 9B). Thus, the planar surfaces of the first gap 130 and second gap 132 do not require tight tolerances for the coolant pump 106 to operate efficiently. Furthermore, the planar surfaces of the first gap 130 and second gap 132 reduces the need to maintain tight radial tolerances.

In some embodiments, the coolant pump impeller 108 is formed in a molding process. Because all molded surfaces on the first side 114 and the second side 116 extend axially, a simple two-piece tooling may be used to make the impeller 108. Therefore, coolant pump impeller 108, including the multiple concentric ribs 110 and multiple vanes 118 are molded to extend axially with two-piece tooling. The coolant pump impeller 108 functions as a closed impeller without a core or moving parts in the production mold. Accordingly, a method of making the impeller 108 with a two-piece mold is provided. The mold halves (i.e., tools) are provided, a first tool for the first side and a second tool for the second side. The tools are placed together to form a cavity. A material is injected or poured into the cavity. The material is at least partially cured, and the tools are separated to release the impeller. Post-molding machining of key surfaces is then carried out.

In some embodiments, the coolant system 104 described herein minimizes the need for external hoses. Preferably, the coolant pump 106 is integrated into the crankcase 120 on the inner/engine side of the pump drive 128 as shown in FIGS. 8B and 9B. In some embodiments, the pump housing 124 is integrated into the crankcase 120. The coolant pump 106 (including the coolant pump impeller 108) and pump drive 128 are inserted into the pump housing 124 and secured therein with a cover 133. Preferably, the coolant pump impeller 108 is driven with a chain drive extending from the crankshaft. See related provisional application Ser. No. 63/544,072, incorporated by reference herein. In some embodiments, the coolant channeling through the engine assembly 102 is accomplished with reduced parts, including hoses as the coolant channels are largely integrated into the crankcase 120 and/or cylinder walls. Thus, the engine assembly 102 includes coolant routing to route coolant to the coolant pump 106 directly through channels formed in the engine rather than routing to the coolant to the coolant pump 106 through a hose external to the crankcase 120 and cylinder housings. In some embodiments, coolant is also routed from the coolant pump 106 back to the engine directly through channels formed in the engine (e.g., crankcase, cylinder walls, cylinder head) rather than first exiting the coolant pump 106 through an external hose.

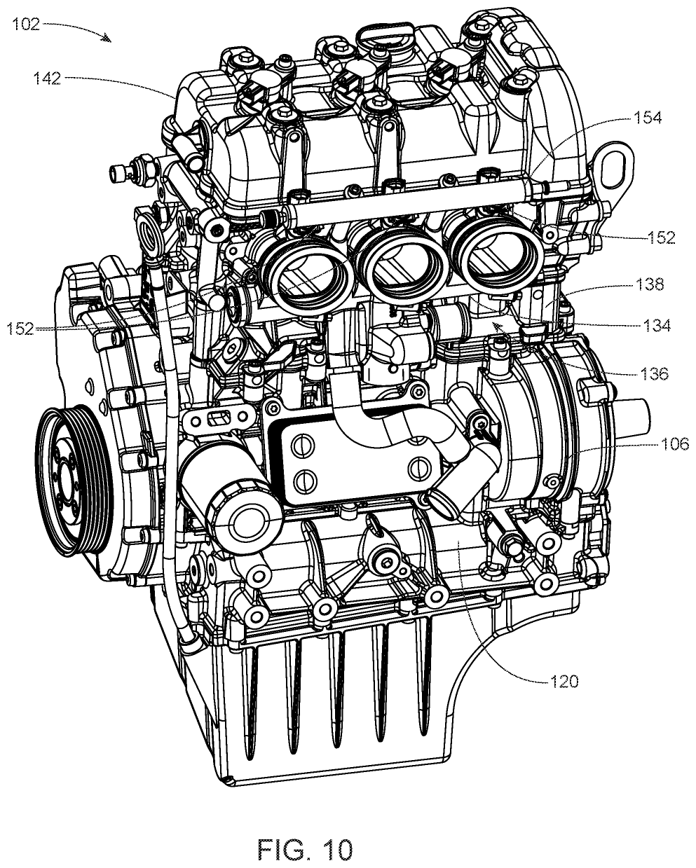

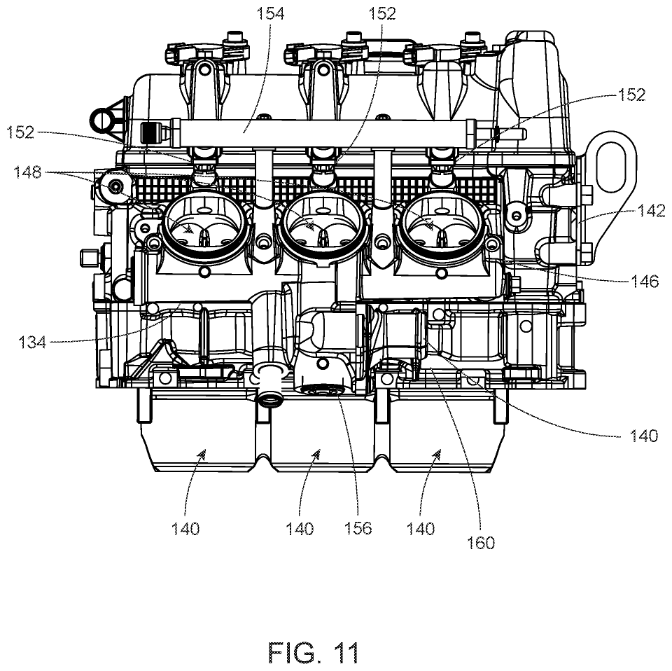

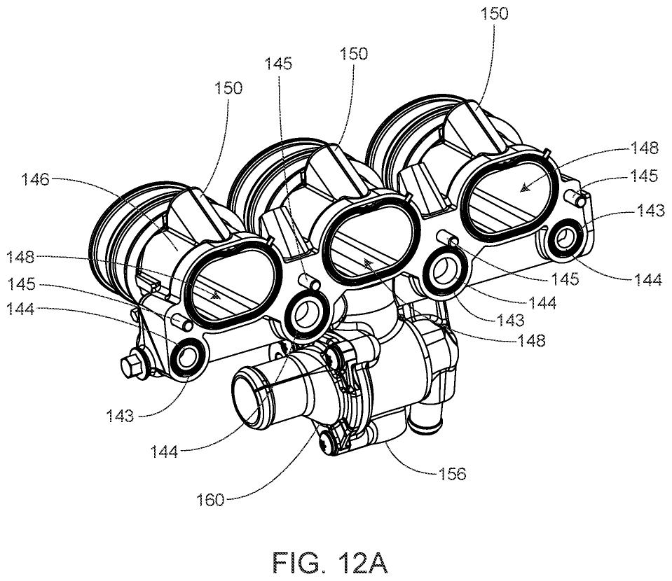

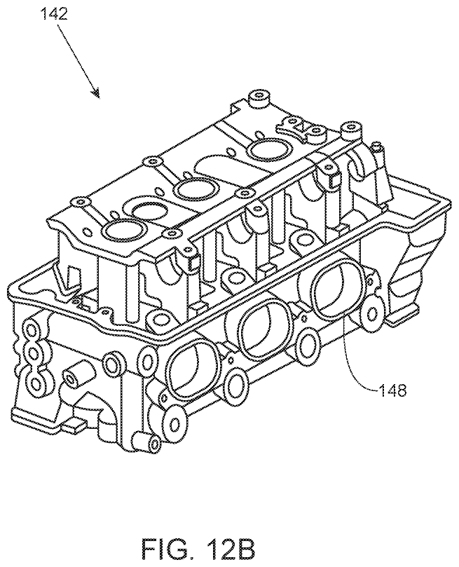

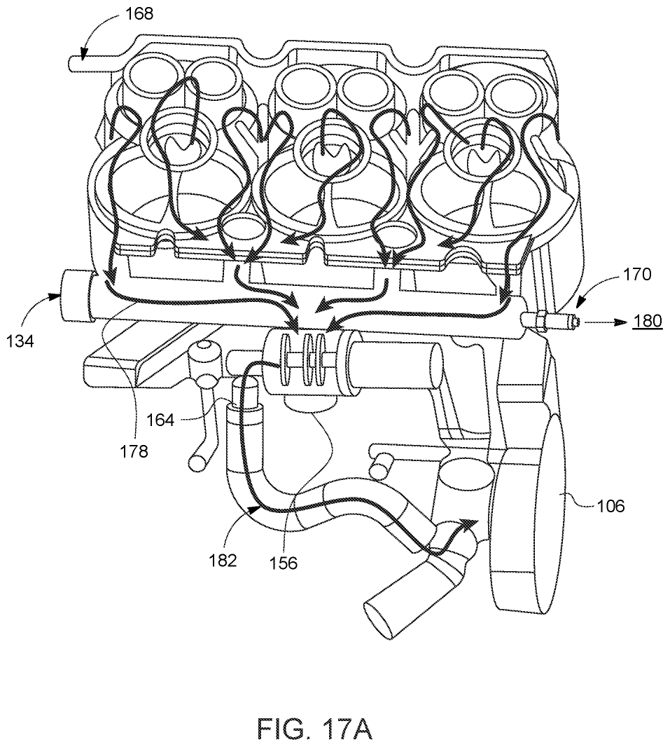

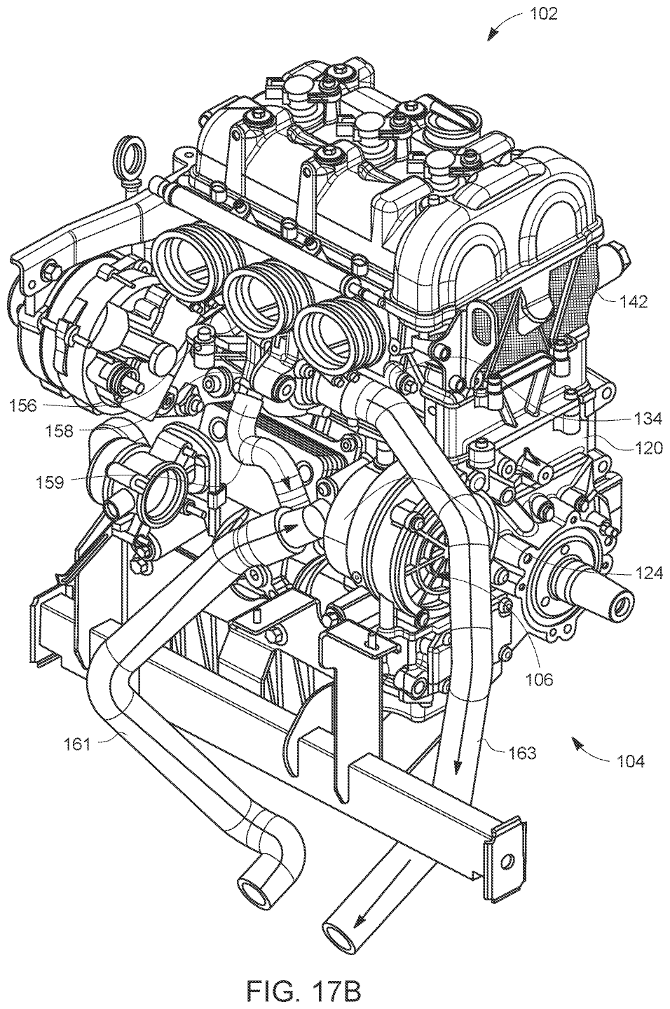

In some embodiments, the engine assembly 102 includes a coolant rail 134 that is configured to be secured to a side 136 of the engine assembly 102 (see, e.g., FIGS. 10-11). The coolant rail 134 includes a body defining a hollow structure (e.g., vessel) that is in fluid communication with and configured to collect coolant from the water jacket 138 that surrounds portions of cylinders 140 and cylinder head 142 of the engine assembly 102. In some embodiments as shown in FIG. 12, the body of the coolant rail 134 includes multiple ports 144 that are positionable in fluid communication with the water jacket 138. Preferably, the coolant rail 134 is coupled to the side of the cylinder head 142 such that the ports 144 align with openings in the water jacket 138. In some embodiments as best shown in FIG. 17A, the coolant is collected from the water jacket 138 by the coolant rail 134 via the ports 144. The coolant is transmitted from the coolant rail 134 back to the coolant pump 106. The coolant rail 134 securely fastens to the engine assembly 102 such that the coolant rail 134 performs the function of coolant hoses in a standard engine. However, because the coolant rail 134 is more robust than coolant hoses, the coolant rail 134 eliminates the hoses. Preferably, the coolant rail 134 removably attaches to the side 136 of the engine assembly 102 with mechanical fasteners. One or more gaskets 143 may be provided to form a fluid-tight seal between the ports 144 and the openings of the water jacket 138. Fasteners 145 are also provided to secure the assembly to the cylinder head 142 as shown in FIG. 11.

In some embodiments, the ports 144 of the coolant rail 134 have different diameters to accommodate different volumes of coolant. In some embodiments as shown in FIG. 12, ports 144 at the ends of the coolant rail 134 have smaller diameters than internally situated ports 144.

In some embodiments, the coolant rail 134 is integrated with an intake system component 146. Preferably, the coolant rail 134 is cast integrally with the intake system component 146. The intake system component 146 includes intake channels 148. In some embodiments, the intake system component 146 defines multiple intake channels 148 (e.g., openings) to receive air and fuel for combustion by the engine assembly 102. The intake channels 148 may be positioned along the upper portion of the body of the coolant rail 134 between the ports 144. The intake channels 148 and the ports 144 are positioned along a planar face of the coolant rail 134 that abuts a planar surface of the cylinder head that defines the cylinder head intake ports 141 and cooling jacket outlets 139. Thus, intake channels 148 that are secured to the engine intake ports are formed together with the coolant rail 134. In a non-limiting example, the coolant rail 134 and the intake system component 146 comprise a single aluminum alloy casting.

In some embodiments, fuel injectors 152 (best shown in FIG. 11) are coupled to the intake channels 148. Preferably, each intake channel 148 defines a fuel injector port 150 to receive fuel from a fuel injector 152 secured to the fuel injector port 150. Thus, fuel may be injected into the intake channels 148 by the fuel injectors 152. In some embodiments, a fuel rail 154 may connect to the fuel injectors 152 to supply fuel to the fuel injectors 152. The fuel rail 154 is preferably a rigid structure through which fuel flows. In some embodiments, the fuel rail 154 is secured to the intake system component 146 with fasteners. As with the coolant rail 134, the fuel rail 154 is a robust structure that may replace hoses.

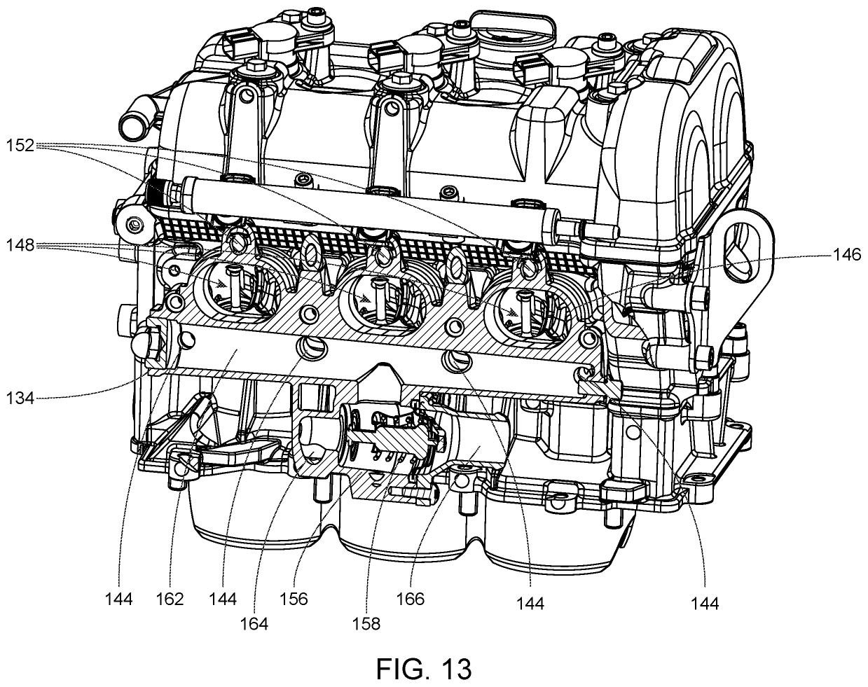

In some embodiments, the coolant rail 134 defines a thermostat housing 156 to house a thermostat 158 (see, e.g., FIGS. 12-13). The engine coolant thermostat housing 156 is integrated with the coolant rail 134 so that it is in fluid communication with the coolant rail downstream of the ports 144 and upstream of the coolant pump 106. Thus, the coolant that enters the coolant rail 134 is fed through the thermostat 158 directly as part of a single component without hoses. Preferably, the thermostat housing 156 is positioned directly below the coolant rail 134 itself. In some embodiments, one side 160 of the thermostat housing 156 is removable to allow insertion of the thermostat 158 into the thermostat housing 156. The removable side 160 is attached to the thermostat housing 156 with fasteners. As shown in FIG. 13, the coolant rail 134 defines a channel 162 where coolant flows from the ports 144 into the thermostat housing 156. The thermostat housing 156 includes a first outlet 164 and a second outlet 166 for the coolant. When the coolant is cool, the thermostat 158 causes the coolant to flow through the first outlet 164 in a closed loop back to the coolant pump 106 as shown in FIG. 17A. When the coolant is at or above a threshold temperature, then the thermostat 158 causes the coolant to flow through the second outlet 166 to a radiator 186 or heat exchanger 188 before returning to the pump.

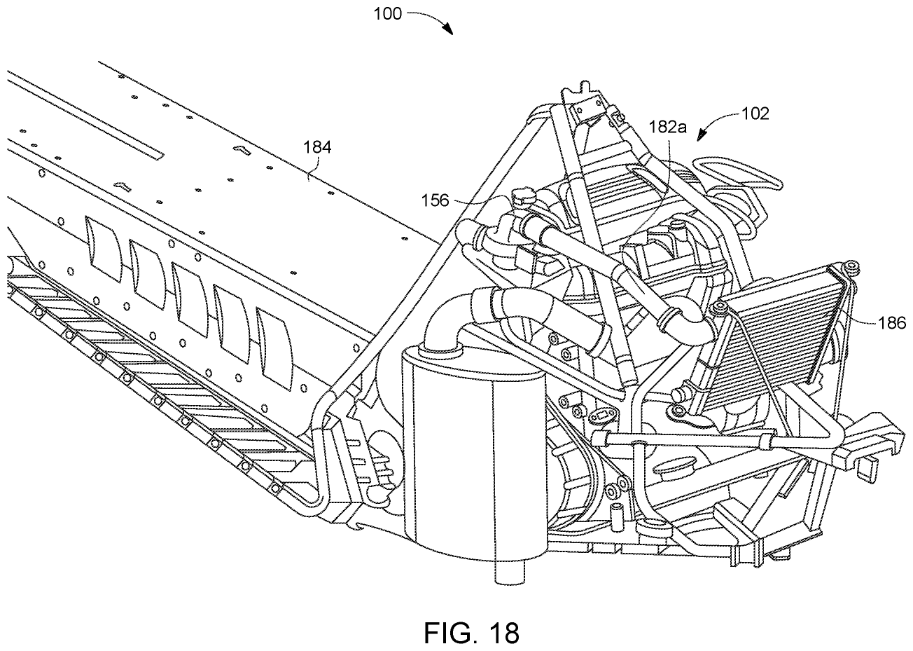

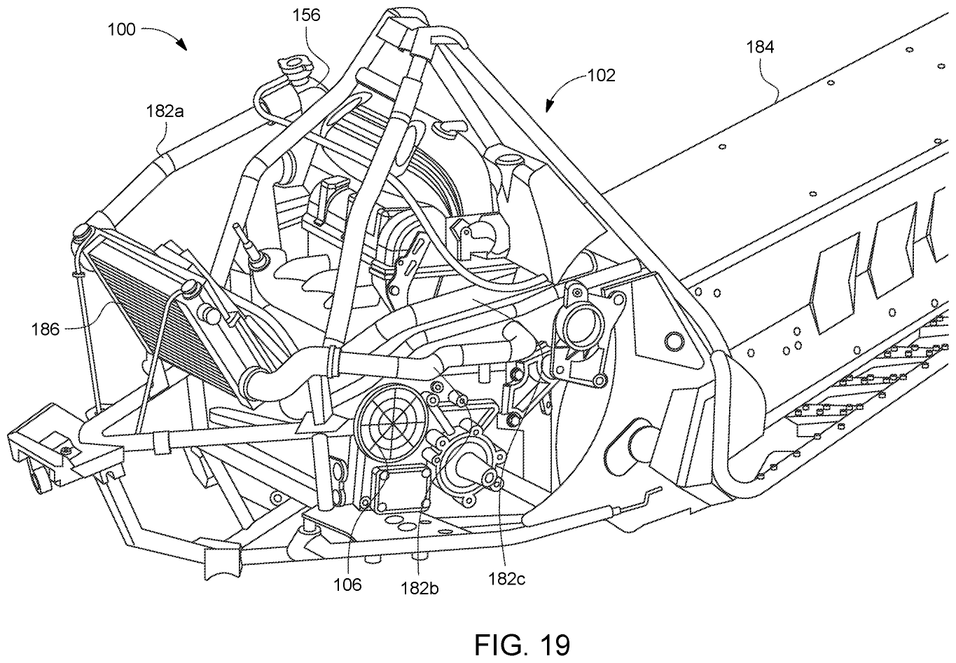

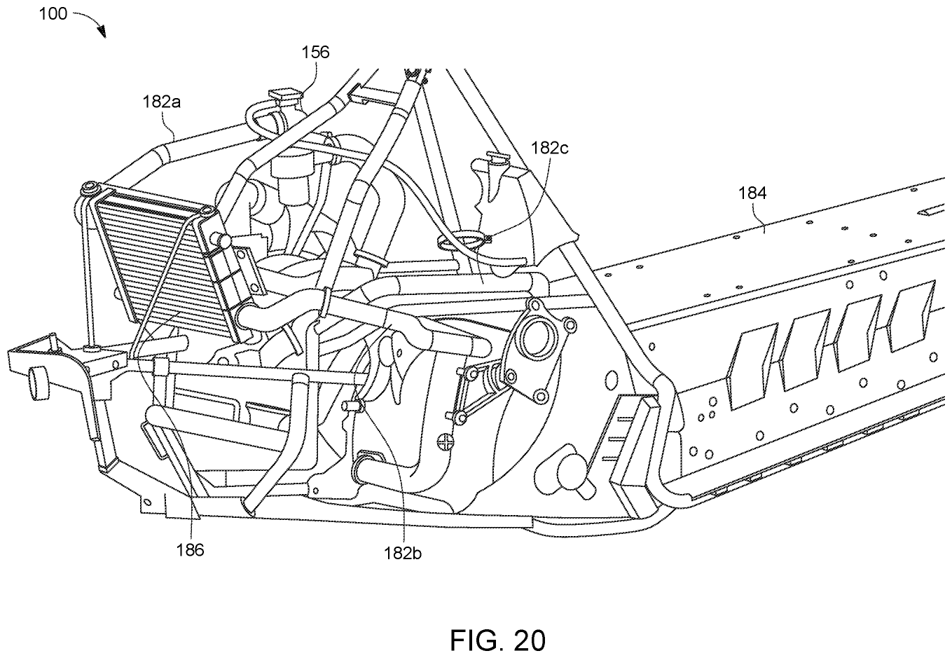

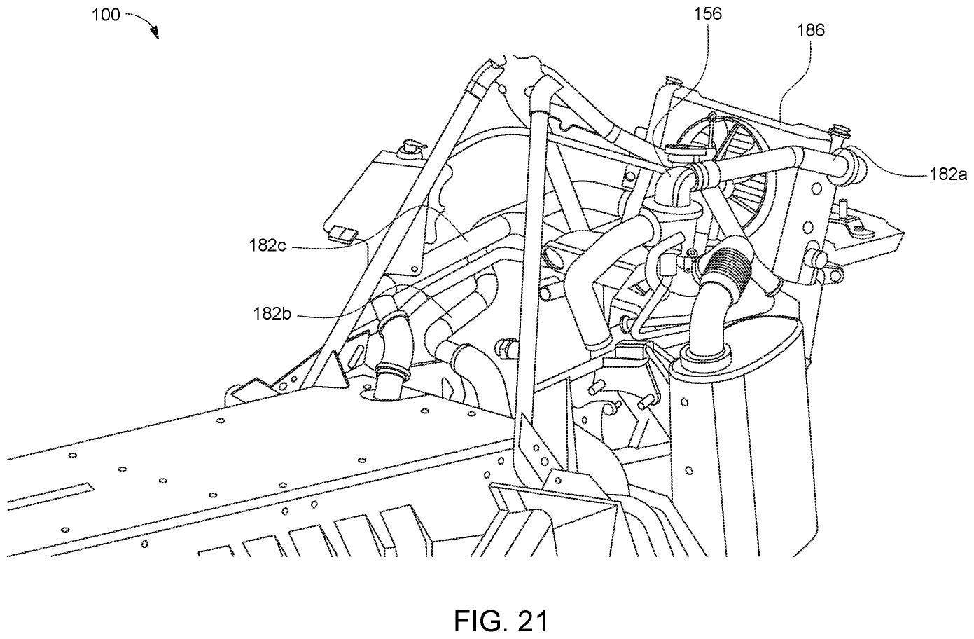

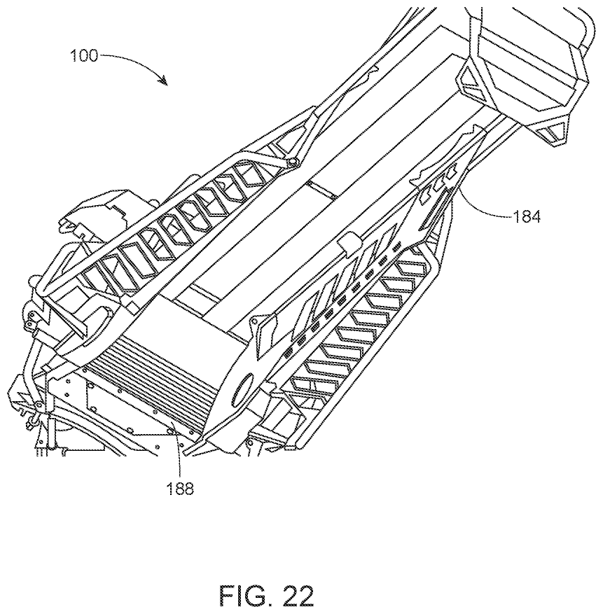

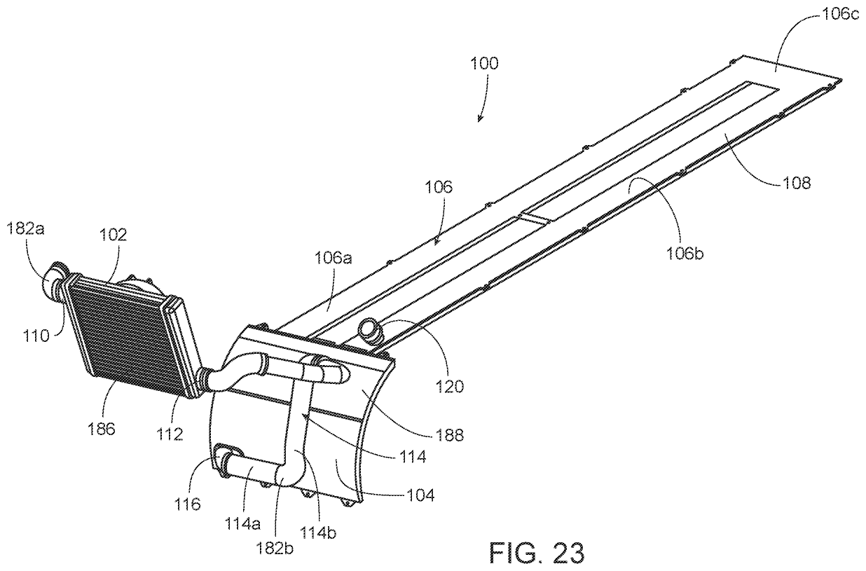

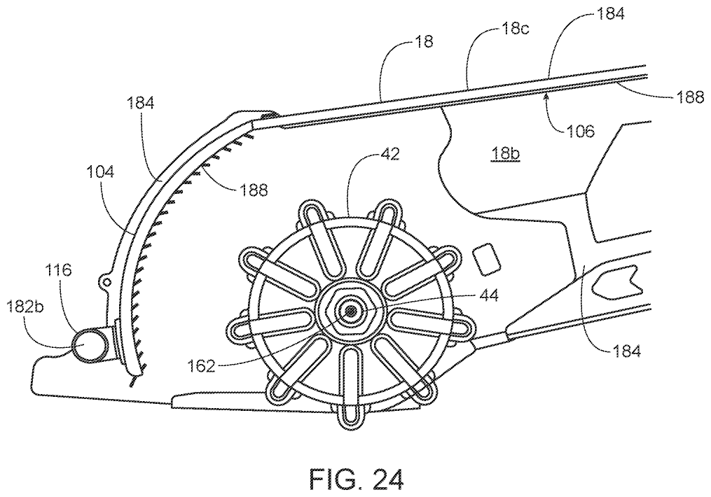

FIG. 17B shows the flow from the thermostat 158 directing the return flow either directly to the coolant pump 106 or to the radiator 186 and/or heat exchanger 188 through fluid line 163 (183a in FIGS. 18-24 in a preferred snowmobile embodiment). Return flow through second fluid line 161 from the radiator 186 and/or heat exchanger 188 is also shown. The bypass line 159 from the thermostat to the coolant pump is for direct return flow to the pump during warm-up.

When coolant is added to an engine assembly 102, air may enter into the coolant system 104. This air may form pockets (e.g., bubbles) where coolant is not present. These air pockets may also block the flow of coolant through the coolant system. Thus, the air should be removed from the coolant system through a bleeding process. Typically, an engine has many bleed screws to allow air trapped at different high spots to be bled off. Typically, a complex procedure of opening the bleed screws in a particular sequence must be performed to ensure that all the air is removed.

In some embodiments, the coolant system 104 described herein includes two bleed fittings 168, 170 that are positioned on the engine assembly 102 such that one of the bleed fittings 168 or 170 will be at or near a highest point 176 in the engine assembly 102 regardless of the orientation or tilt of the engine assembly 102. Air will then travel up to this single highest point 176 and will be removed from the engine assembly 102.

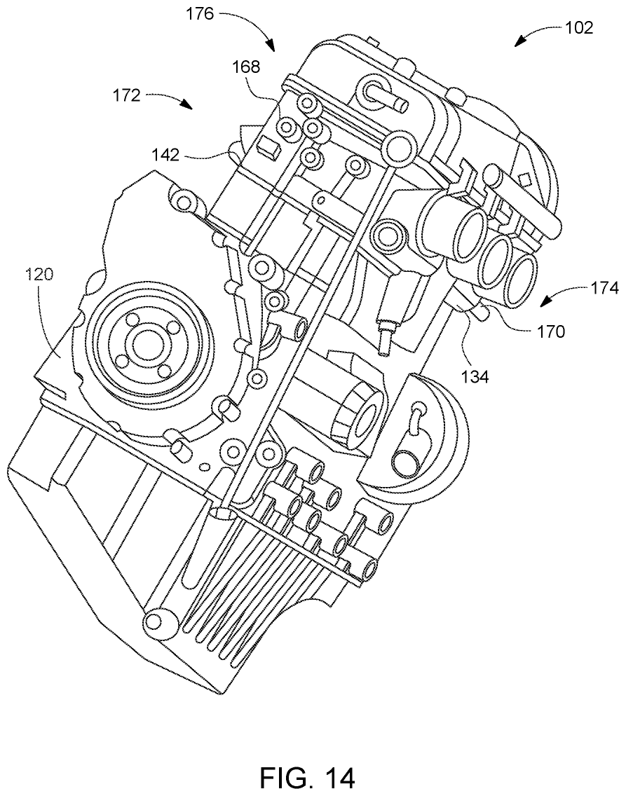

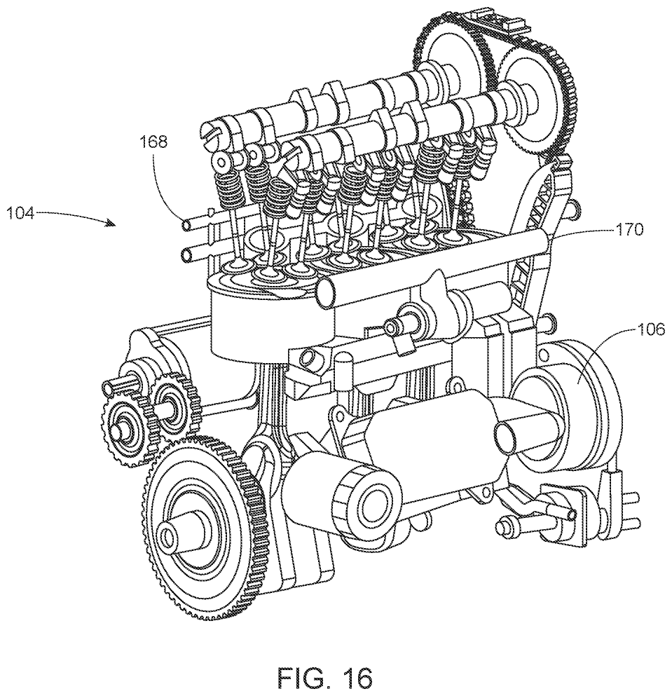

In some embodiments, the coolant system 104 includes a first bleed fitting 168 located at a first corner 172 of the engine assembly 102 and a second bleed fitting 170 located at a second corner 174 of the engine assembly 102 (see, e.g., FIGS. 14-17). The first and second bleed fittings 168, 170 are provided on opposite corners 172, 174 of the engine assembly 102 such that either the first bleed fittings 168 or the second bleed fitting 170 is at or near the highest point 176 of the coolant system 104 based on the orientation or tilt of the engine assembly 102. The term orientation or tilt of the engine assembly 102 is in relation to the vehicle 100. The engine orientation includes the tilt of the engine assembly 102 as installed in a vehicle 100. The engine assembly 102 may have a first configuration for a snowmobile where the engine assembly 102 is located in front of the snowmobile and is tilted toward the operator. The engine assembly 102 may have a second orientation for a UTV or ATV where the engine assembly 102 is located behind the passengers and tilts toward the passengers. In one preferred application, such as for a snowmobile 100, the combustion air intake may be on the rear of the cylinder head 142 with the combustion exhaust exiting from the front of the cylinder head 142. In another preferred application, such as for an off-road UTV, the air intake may be on the front side of the cylinder head 142 with the exhaust exit on the rear of the cylinder head 142.

Preferably, the first and second bleed fittings 168, 170 are positioned such that regardless of the tilt of the engine assembly 102 air may be bled from the system as one of the fittings will be at or near the highest point of the coolant system. Thus, in some embodiments, the first and second bleed fittings 168, 170 accommodate more than one engine orientation, whereby either the first bleed fitting 168 or the second bleed fitting 170 is at or near the highest point 176 of the coolant system 104 for any of the different engine orientations. In some embodiments, either the first or the second bleed fitting 168 or 170 is at the highest point 176 of the coolant system 104 for any of the engine orientations. Thus, for a given engine orientation, either the first or the second bleed fitting 168 or 170 provides a single bleeding point for the entire coolant system 104.

In some embodiments, the first bleed fitting 168 is provided at the top of the water jacket 138 of the cylinder head 142 and fluidly communicates with the cylinder head portion of the water jacket 138 that flows around the cylinders 140 and lower portion of the head 142. In some embodiments, the second bleed fitting 170 is provided at an end of a coolant rail 134 and is fluidly coupled to the coolant rail 134.

In some embodiments, the bleed fittings 168, 170 include a screw to perform manual bleeding. In these embodiments, the screws can be opened and closed to perform manual bleeding without engine cranking. In some embodiments, the bleed fittings 168, 170 include a hose coupled to a bleeding reservoir (e.g., expansion tank 180) for a continuous self-bleeding system. The expansion tank 180 is a reservoir that is configured to receive air escaping from either the first bleed fitting 168 or the second bleed fitting 170.

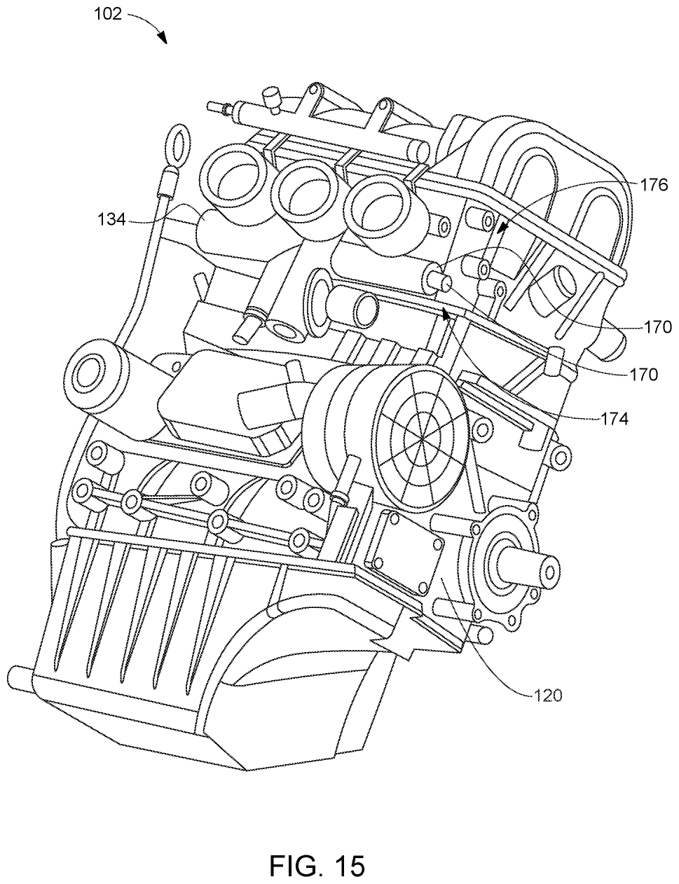

FIG. 14 illustrates the engine assembly 102 in a first configuration where the engine assembly 102 is tilted such that the first bleed fitting 168 is at the highest point 176 of the coolant system 104. FIG. 15 illustrates the engine assembly 102 in a second configuration where the engine assembly 102 is tilted such that the second bleed fitting 170 is at the highest point 176 of the coolant system 104.

FIG. 17A illustrates an embodiment of air and coolant flow 178. In this embodiment, the engine assembly 102 is configured such that the fitting 170 located on the coolant rail 134 is at the highest point 176. The fitting 170 is in fluid communication with an expansion tank 180 to allow air to exit from the coolant system 104. Coolant that enters the coolant rail 134 flows downward into the thermostat housing 156 while air that enters the coolant rail 134 with the coolant flows upward to the fitting 170 located at the highest point. If the coolant is below a threshold temperature, the thermostat 158 causes the coolant to flow out of the first outlet 164 and back to the coolant pump 106 in a closed loop. If the coolant is at or above a threshold temperature, the thermostat 158 causes the coolant to flow out of the second outlet 166 to a radiator 186 or heat exchanger 188.

The bleed system described herein simplifies the coolant addition process. In some embodiments, the engine assembly 102 can be filled with coolant without manually opening air bleeding screws. At first ignition of the engine assembly 102, any remaining air in the coolant system 104 escapes by one of the fittings 168, 170 into the expansion tank 180. Dissolved air in the coolant can discharge during engine operation without any manual bleeding.

Depending on the engine application, one of the two bleed fittings 168, 170 is chosen to run to the coolant expansion tank 180. The fitting at the highest point 176 of the engine coolant system 104 is chosen depending on engine position. As described herein, the fittings 168, 170 are located at both cylinder head 142 and coolant rail 134 to guarantee a fitting 168 or 170 is located at the highest point 176 on different engine orientations. In some embodiments, a fluid line 182 (e.g., a hose) leads from the selected bleed fitting 168 or 170 (depending on engine position) to the expansion tank 180. In some embodiments, after filling with coolant, the engine assembly 102 can be started to remove air bubbles and the level of coolant can be confirmed. Coolant from the expansion tank 180 is pulled back into the radiator 186 or heat exchanger 188 with a negative pressure. Thus, the first and second bleed fittings 168, 170 minimize trapped air introduced into the coolant system 104 from filling the coolant system 104 with coolant.

A method of using the engine assembly 102 includes installing the engine assembly 102 in the vehicle 100 with a given engine orientation. In some embodiments, either the first bleed fitting 168 or the second bleed fitting 170 is selected to provide the coolant to the expansion tank 180 based on which of the first bleed fitting 168 or the second bleed fitting 170 is positioned at the highest point 176 of the coolant system 104. If the engine assembly 102 is installed in the vehicle 100 such that the first bleed fitting 168 is at the highest point 176, then the first bleed fitting 168 is selected to provide coolant to the expansion tank 180. If the engine assembly 102 is installed in the vehicle 100 such that the second bleed fitting 170 is at the highest point 176, then the second bleed fitting 170 is selected to provide coolant to the expansion tank 180. In some embodiments, a fluid line 182 is connected from the selected bleed fitting 168 or 170 to the expansion tank 180. Preferably, the non-selected bleed fitting is sealed off to prevent coolant from leaking out of the coolant system 104.

The described coolant bleeding system provides for modularity of the engine assembly 102. In some embodiments, regardless of the tilt of the engine assembly 102, one of the bleed fittings 168, 170 will be at the highest point 176 in the coolant system 104. Therefore, the same engine assembly 102 can be used in different orientations for different applications. For example, the same engine assembly 102 can be used with a first orientation in a snowmobile and a second orientation in an off-road vehicle (e.g., UTV, ATV, etc.).

Referring now to FIGS. 18-22, the coolant system 104 may be used in a vehicle 100 (e.g., snowmobile) that includes one or both of a radiator 186 and a heat exchanger 188. In some embodiments, coolant exiting the water jacket 138 enters a thermostat housing 156 where a thermostat 158 causes the coolant to flow to the radiator 186 via a first line 182A. The coolant exits the radiator 186 and travels through a second line 182B to the inlet of a heat exchanger 188 located within the tunnel 184 of the snowmobile. Upon exiting from the heat exchanger 188, the coolant returns to the coolant pump via a third line 182C. It should be noted that in the embodiment shown in FIGS. 18-22, the thermostat housing 156 is separate from the coolant rail 134. In other embodiments, the thermostat housing 156 is integrated with the coolant rail 134 as described herein.

The fasteners used throughout the present disclosure may be nut and bolt fasteners used in automobile industry. In some embodiments, the bolt in such fasteners may have a hex-head, followed by a hex-headed cap screw and a stud.

It is to be noted that different values and parameters mentioned in the description are not intended to bound the specification in any manner.

As used herein, the following terms take the meanings explicitly associated herein, unless the context clearly dictates otherwise. The terms “front,” “forward,” “rear,” and “rearward” are defined relative to the steering mechanism, such as a steering wheel, and the portion of the driver seat that is farthest from such steering mechanism. The terms “front” and “forward” indicate the direction from the portion of the driver seat farthest from the steering mechanism toward the steering mechanism. The terms “rear” and “rearward” indicate the direction from the steering mechanism toward the farthest portion of the driver seat. The terms “height,” “vertical,” “upper,” “lower,” “above,” “below,” “top,” “bottom,” “topmost,” and “bottom-most” are defined relative to vertical axis of the vehicle. The vertical axis is non-parallel to the longitudinal axis and is defined as parallel to the direction of the earth's gravity force on the vehicle when the vehicle is on horizontal ground. The term “lateral” is defined relative to the lateral axis of the vehicle. The lateral axis is non-parallel to the longitudinal and vertical axes. The longitudinal axis extends forward and rearward through the vehicle in a horizontal plane.

The term “configured” as used herein means an element being one or more of sized, dimensioned, positioned, or oriented to achieve or provide the recited function or result. The term “directly coupled” as used herein means that a component contacts (for example, when bolted) or is welded to another component. The term “indirectly coupled” as used herein means that a first component is coupled to a second component by way of one or more intervening components that are directly coupled to the first and second components. A first component that is indirectly coupled to a second component is directly coupled to a third component, which may be directly coupled to the second component or to a fourth component that is directly coupled to the second component. The term “coupled” should therefore be understood to disclose both direct and indirect coupling of components or elements that are described as being coupled to each other.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

The term “engine assembly” used throughout the disclosure refers to an engine having a cylinder head, a cylinder block, a crankshaft, camshafts, a camshaft drive or a timing chain, a valve cover, and other associated parts.

The term “or” is an inclusive grammatical conjunction to indicate that one or more of the connected terms may be employed. For example, the phrase “one or more A, B, or C” or the phrase “one or more As, Bs, or Cs” is employed to discretely disclose each of the following: i) one or more As, ii) one or more Bs, iii) one or more Cs, iv) one or more As and one or more Bs, v) one or more As and one or more Cs, vi) one or more Bs and one or more Cs, and vii) one or more As, one or more Bs, and one or more Cs. The term “based on” as used herein is not exclusive and allows for being based on additional factors not described. The articles “a,” “an,” and “the” include plural references. Plural references are intended to also disclose the singular.

While the preferred embodiments of the invention have been illustrated and described, as noted above, many changes can be made without departing from the spirit and scope of the invention. Each disclosure of a component preferably having a feature or characteristic is intended to also disclose the component as being devoid of that feature or characteristic unless the principles of the invention clearly dictate otherwise. Accordingly, the scope of the invention is not limited by the disclosure of the preferred embodiment. Instead, the invention should be determined entirely by reference to the claims that follow. It should also be noted that the claim dependencies or combinations of elements recited in the claims do not reflect an intention to forgo claiming other subject matter disclosed herein. Instead, this disclosure is intended to also disclose the subject matter of any combination of any two or more of the claims, such that subsequent claim sets may recite that any one of the dependent claims depends from any other one or more claims, up to and including all other claims in the alternative (such as “The apparatus or method of any one of the preceding or subsequent claims . . . ”). This disclosure is also intended to disclose the subject matter of any one of the dependent claims, as if it were an independent claim, with or without all or a portion of the subject matter of the original independent claim(s) or any other subject matter disclosed herein.

The embodiments of the invention in which an exclusive property or privilege is claimed are defined as follows:

1. A coolant pump impeller for an engine assembly of a vehicle, the coolant pump impeller comprising:
multiple concentric ribs extending axially on a first side of the coolant pump impeller;
multiple vanes extending axially on a second side of the coolant pump impeller, the multiple vanes being configured to pump coolant,
wherein the coolant pump impeller is a closed-style impeller that defines multiple openings that are configured to permit the coolant to pass from the first side to the second side.

2. The coolant pump impeller of claim 1, wherein the concentric ribs extend on an intake side of the impeller and are configured to reduce backflow of the coolant, the ribs also configured to strengthen the coolant pump impeller.

3. The coolant pump impeller of claim 2, wherein the engine assembly includes a pump housing with an internal face, wherein the concentric ribs extend toward the internal face of the pump housing and the ribs having inner edges being positioned closely adjacent the internal face.

4. The coolant pump impeller of claim 3, wherein the internal face is a planar surface.

5. The coolant pump impeller of claim 3, wherein the vanes on the second side of the impeller extend outwardly from a central hub that surrounds an axis of rotation of the impeller such that the vanes extend across at least one of the concentric ribs on the first side as viewed from an axial direction, and wherein a curved wall extends between the ribs on the first side and the vanes on the second side of the impeller, the curve of the wall extending from closer to the first side to closer to the second side of the impeller as the wall extends radially outwardly from the multiple openings between the vanes at inner ends of the vanes near an impeller hub.

6. The coolant pump impeller of claim 1, further including a coolant pump housing formed integral with a crankcase of the engine assembly, the pump housing including an input opening, an impeller chamber, and an exit port leading to an engine liquid coolant jacket, the coolant pump housing also covering a pump drive mechanism.

7. A crankcase for a vehicle comprising:
a coolant pump housing including a portion for housing a coolant pump impeller;
a coolant pump drive housing integrally formed adjacent the coolant pump housing, the drive housing covering a drive gear, a drive shaft, and a drive chain entrained with a crankshaft.

8. The crankcase of claim 7, further comprising a housing portion covering an oil pump driven by the same chain that drives the coolant pump.

9. The crankcase of claim 7, further comprising a coolant pump cover, the coolant pump cover also providing access to a chain tensioner component.

10. A method of making the coolant pump impeller of claim 1, comprising molding the multiple concentric ribs and multiple vanes to extend axially with two-piece tooling.

11. An engine assembly of a vehicle, the engine assembly comprising:
a coolant rail configured to be secured to a side of the engine assembly, the coolant rail being configured to collect coolant from a water jacket that surrounds portions of cylinders and a cylinder head of the engine assembly; and
wherein the coolant rail is integrated with an intake system component, the coolant rail and the intake system component being cast integrally therewith.

12. The engine assembly of claim 11, wherein the coolant rail includes multiple ports in fluid communication with the water jacket.

13. The engine assembly of claim 11, wherein the coolant rail is coupled to a side of the cylinder head.

14. The engine assembly of claim 11, wherein the coolant rail is configured to collect the coolant and is configured to transmit the coolant to a coolant pump.

15. The engine assembly of claim 11, wherein the intake system component defines multiple intake channels that are configured to receive air and fuel.

16. The engine assembly of claim 15, wherein each intake channel defines a fuel injector port that is configured to receive fuel from a fuel injector secured to the fuel injector port, wherein multiple fuel injectors are coupled to a fuel rail.

17. The engine assembly of claim 11, wherein the coolant rail further defines a thermostat housing to house a thermostat.

18. The engine assembly of claim 17, wherein coolant that enters the coolant rail is fed through the thermostat directly without hoses.

19. An engine assembly of a vehicle, the engine assembly comprising:
a coolant system configured to circulate coolant through the engine assembly;
a first bleed fitting in fluid communication with the coolant system; and
a second bleed fitting in fluid communication with the coolant system,
wherein the first and second bleed fittings are disposed on opposite corners of the engine assembly such that the first bleed fitting or the second bleed fitting is at a highest point of the coolant system based on an orientation of the engine assembly.

20. The engine assembly of claim 19, wherein the first bleed fitting is provided at a top of a water jacket of a cylinder head, and wherein the second bleed fitting is provided at an end of a coolant rail.

21. The engine assembly of claim 19, further comprising an expansion tank to receive air escaping from the first bleed fitting or the second bleed fitting.

22. The engine assembly of claim 19, wherein the first bleed fitting or the second bleed fitting is disposed at the highest point of the coolant system for any of the more than one engine orientation, whereby the first bleed fitting and the second bleed fittings accommodate more than one engine orientation, wherein, for a given engine orientation, the first bleed fitting or the second bleed fitting provides a single bleeding point for the entire coolant system.

23. A method of using the engine assembly of claim 19, comprising:
installing the engine assembly in the vehicle with a given engine orientation;
selecting the first bleed fitting or the second bleed fitting to provide the coolant to an expansion tank based on which of the first bleed fitting or the second bleed fitting is positioned at the highest point of the coolant system; and
connecting a fluid line from the selected bleed fitting to the expansion tank.
